(19) United States
(12) Patent Application Publication
(10) Pub. No.: US 2005/0190468 A1
(43) Pub. Date: Sep. 1, 2005

(54) Data recording apparatus and the method thereof

(75) Inventor: Kiyoshige Noguchi, Tokyo (JP)

Correspondence Address: MCGINN & GIBB, PLLC, 8321 OLD COURTHOUSE ROAD, SUITE 200, VIENNA, VA, 22182-3817, US

(73) Assignee: Fuji Jukogyo Kabushiki Kaisha, Tokyo (JP)

(21) Appl. No.: 11/065,069

(22) Filed: Feb. 25, 2005

(30) Foreign Application Priority Data
Feb. 27, 2004 (JP) P2004-055042

(51) Int. Cl. G11B 5/00

(52) U.S. Cl. 360/1

(57) ABSTRACT

In a shutdown processing performed before the power supply is shut down, acquisition contents, an acquired condition, and a current operating state in a data control unit are recorded in a data recording unit as an operation history. Then, in initiation processing which is performed after a power-on, the recorded operation history is read from the data recording unit, and the operating state at the time of the shutdown is restored based on the read operation history.

This application claims foreign priority based on Japanese patent application No. JP.-2004-055042, filed on Feb. 27, 2004, the contents of which is incorporated herein by reference.

### BACKGROUND OF THE INVENTION

The present invention relates to a data recording apparatus and a data recording method, and more particularly, to an apparatus and a method for recording vehicle data including control parameters in a control unit equipped in a vehicle.

Conventionally, a data recording apparatus is known for recording control parameters and the like of a controller equipped in a vehicle in order to identify a faulty state of the vehicle. For example, JP-A-2002-070637 discloses a data recording apparatus for reliably and efficiently recording data for the controller. According to this data recording apparatus, operating conditions such as a name signal to be acquired, a sampling rate, a trigger mode, and the like, i.e., an operating state is set for the data recording apparatus. Based on this operating condition, verious various data (i.e., control parameters) in the controller associated with the vehicle are sampled in time series, and the acquired sampled data are stored in SRAM at anytime as required. Then, upon establishment of a predetermined trigger condition which corresponds to a condition under which effective data can be acquired for identifying a faulty state of the vehicle, a sequence of sampled data stored in the SRAM is stored in a data recording unit.

Generally, in this type of the data recording apparatus, the operating condition is reset each time when it is shut down. Therefore, conventionally, each time the system of the data recording apparatus is started in each operation cycle of the vehicle, the operating state is set again, such that data is recorded in the thus set operating state. However, when the operating state is reset each time the data recording apparatus is shut down, previously recorded vehicle data would be inconveniently duplicated as they are recorded in each operation cycle because the operating state is always set to an initial operating state in each operation cycle.

### SUMMARY OF THE INVENTION

The present invention has been made in view of such a circumstance, and its object is to efficiently record data by making an operating state of a data recording apparatus continuous.

To solve foregoing problems, according to a first aspect, the present invention provides a data recording apparatus for recording a vehicle data including a control parameter in a control unit equipped in a vehicle in a data recording unit accessible by an external system. The data recording apparatus has a data control unit for recording a time-series vehicle data acquired from the vehicle based on acquisition contents indicative of the type of the vehicle data to be recorded in the data recording unit in accordance with an acquiring condition indicative of a condition under which the vehicle data can be acquired for effectively identify a faulty state of the vehicle, a shut down processing unit for recording the acquisition contents, the acquired condition, and the current operating state in the data control unit in the data recording unit as an operation history in a shutdown processing performed before the data recording apparatus is powered off, and an initiation processing unit for reading the operation history recorded in the data recording unit and restoring the operating state at the time of the shutdown based on a read operation history in an initiation processing performed after turning on the power supply.

Further, according to the present invention, the initiation processing unit preferably sets the operating state of the data control unit based on initially set the data previously recorded in the data recording unit when the operation history is not recorded in the data recording unit. Also, in the present invention, it is preferable that the data recording apparatus further has a sub-battery for supplying power to the data recording apparatus when the power supplied from the vehicle to the data recording apparatus is shut down, wherein the initiation processing unit preferably recharges the sub-battery, during the initiation processing, using the power supplied from the vehicle to the data recording apparatus when the power stored in the sub-battery is equal to or less than a predetermined amount.

Also, in the present invention, preferably, the data recording apparatus further has a power supply control unit for turning on the power supply based on a detection signal outputted from the vehicle when a driver's get-in behavior is sensed. In this event, the power supply control unit preferably turns on the power supply based on an ON signal outputted from the vehicle when an ignition switch provided in the vehicle is turned on, and based on a change in a communication signal outputted from the control unit when the ignition switch is turned on. Also, the power supply control unit may turn on the power supply based on a timer signal outputted every predetermined time, and the initiation processing unit may output a data request signal to the control unit, performs the initiation processing when determining that the initiation processing unit receives a predetermined signal corresponding to the data request signal from the control unit, and instruct the power supply control unit to shut down the power supply when determining that the initiation processing unit does not receive the predetermined signal.

According to a second aspect, the present invention provides a data recording method of the data recording apparatus for recording a vehicle data including a control parameter in a control unit equipped in the vehicle in a data recording unit accessible by an external system. The data recording method has a first step of recording the time-series vehicle data acquired from the vehicle based on acquisition contents indicative of the type of the vehicle data to be recorded in the data recording unit in accordance with an acquired condition indicative of a condition under which the vehicle data can be acquired for effectively identifying a faulty state of the vehicle, a second step of recording the acquisition contents, the acquired condition, and the current operating state in the data control unit in the data recording unit as an operation history in the shutdown processing performed before the data recording apparatus is powered off, and a third step of reading the operation history recorded in the data recording unit, and restoring the operating state at the time of the shutdown based on the read operation history.

In the present invention, the third step preferably sets the operating state of the data control unit based on initially set data previously recorded in the data recording unit when the operation history is not recorded in the data recording unit. Also, in the present invention, it is preferable that the third step recharges a sub-battery using the power supplied from the vehicle to the data recording apparatus when the power stored in the sub-battery is equal to or less than a predetermined amount during the initiation processing, wherein the sub-battery preferably supplies power to the data recording apparatus when the power supplied from the vehicle to the data recording apparatus is shut down.

According to the present invention, the current operating state of the data recording apparatus is recorded in the data recording unit as the operation history in the shutdown processing before the power supply is shut down. Then, at the next start, the operating state is set based on the recorded operation history so as to restore the operating state at the time of the shutdown. In this way, the operating state of the recording apparatus can be made continuous in sequential operation cycles. Consequently, the operating state is not reset every operation cycle even when data is recorded over sequential operation cycles, thus making it possible to prevent unnecessary data from being recorded. In this way, the data recording apparatus can efficiently record necessary data, and improve the reliability of recorded data.

### BRIEF DESCRIPTION OF THE DRAWINGS

FIG. 1 is an explanatory diagram of a vehicle to which a data recording apparatus is applied according to an embodiment of the present invention.

FIG. 2 is a block diagram illustrating a system configuration of a recording apparatus.

FIG. 3 is an explanatory diagram showing exemplary mode files.

FIG. 4 is a flow chart illustrating a data recording procedure according to the embodiment of the present invention.

FIG. 5 is the flow chart illustrating a procedure of the operating state setting processing.

FIG. 6 is the explanatory diagram showing a change over time of time-series vehicle data recorded in a data recording unit.

FIG. 7 is the flow chart illustrating a detailed procedure of a shutdown processing.

### DESCRIPTION OF THE PREFERRED EMBODIMENT

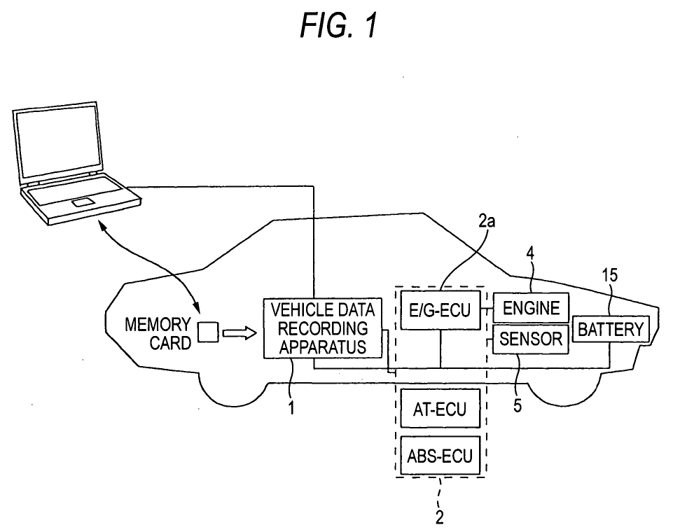

FIG. 1 is an explanatory diagram of a vehicle to which a data recording apparatus according to an embodiment of the present invention is applied. First, prior to a description on the data recording apparatus 1 (hereinafter simply called the “recording apparatus”), the description will be made on the vehicle to which the recording apparatus 1 is applied. The vehicle is equipped with an electronic control unit 2 (hereinafter called the “ECU”) for controlling various devices installed in the vehicle. The ECU 2 is centered at a microcomputer in the configuration, and this embodiment will be described mainly in connection with an engine control unit 2a (hereinafter called “E/G-ECU”) for controlling an engine 4, as a representative unit of the ECU 2. However, the present invention can be applied similarly to a transmission control unit (AT-ECU) for controlling an automatic transmission; an ABS control unit (ABS-ECU) for controlling an anti-lock brake system; and the like. In this specification, the term “ECU” is used to collectively refer to these control units.

The ECU 2 is applied with sensor detected signals from various sensors 5 for detecting the state of an object under control. This type of sensors 5 may include an intake air flow sensor, an intake pressure sensor, a vehicle speed sensor, an engine rotation speed sensor, a water temperature sensor, an acceleration sensor (G sensor), and the like. The ECU 2 performs operations associated with various control amounts based on the sensor detected signals in accordance with a previously set control program. Then, control amounts calculated by the operations are outputted to various actuators. For example, the E/G-ECU 2a performs operations associated with a fuel injection pulse width (fuel injection amount), an ignition timing, a throttle valve opening degree, and the like, and outputs control signals in accordance with the calculated control amounts to various actuators. The respective ECUs 2 equipped in the vehicle are interconnected through K-Line (one standard of serial communication) or CAN (Controller Area Network), so that the respective ECUs 2 can share their information through serial communications which are made by way of these communication lines. Each of the control units which make up the ECU 2 need not be commonly applied with all of the aforementioned sensor detected signals, but may be applied with sensor detected signals required by the respective control units to perform the controls.

The ECU 2 is also installed with a self diagnosis program for diagnosing faults in each component under control to automatically diagnose the operating states of the microcomputer and sensors 5 at an appropriate period. If a fault is recognized by the diagnosis, the ECU 2 generates a diagnosis code corresponding to the details on the fault, and stores the diagnosis code in a backup RAM of the ECU 2 at a predetermined address. The ECU 2 also performs an alarming process as required by turning on or blinking a MIL lamp or the like.

Next, a description will be made on the recording apparatus 1 according to this embodiment. This recording apparatus 1 is a removable apparatus for recording various data related to the vehicle (hereinafter called the “vehicle data”), and is equipped in the vehicle as required. The vehicle data recorded by the recording apparatus 1 may be control parameters for the ECU 2. Here, the “control parameters” are typically assumed to be control amounts calculated in the ECU 2, but also include parameters (an engine rotation speed (rpm), a vehicle speed (km/h), and the like) and a learning value (control learning map) for use in calculating the control amounts. The recording apparatus 1 may also record sensor detected signals detected by various sensors 5, and a peripheral information of the vehicle, as an information associated with the control parameters. The peripheral information of the vehicle is the information related to the surroundings of the vehicle, and includes a temperature outside the vehicle, a pressure outside the vehicle, an altitude around the vehicle, an absolute position (longitude, latitude), and the like.

The recording apparatus 1 is equipped in the vehicle when a periodic inspection is made, when the vehicle is carried into a service factory due to some fault found by the user, and the like. In the former case, the vehicle is subjected to a test run by a service person. In this event, the recording apparatus 1 acquires vehicle data in the test run period at all times, and records the vehicle data as required. In the latter case, on the other hand, the vehicle is once returned to the user except for a case where the service person can readily identify the fault. In this event, the recording apparatus 1 acquires vehicle data at all times in a situation in which the user is normally operating the vehicle, and records the acquired vehicle data as required. After the test run conducted by the service person is terminated, or when the vehicle is again carried into the service factory, the recording apparatus 1 is removed from the vehicle. Then, the vehicle data recorded in the recording apparatus 1 are used for identifying the presence or absence of the fault experienced by the vehicle, or identifying the cause of the fault.

Since the recording apparatus 1 is not normally equipped in the vehicle, there is no exclusive space previously ensured in the vehicle for an installation, unlike the ECU 2. In this embodiment, the recording apparatus 1 is installed in a passenger's space (in the cabin), and is electrically connected to various cables provided in the vehicle. Here, from a viewpoint of decreasing works loaded on a service person, the recording apparatus 1 can be preferably mounted simply and in a short time, and from the viewpoint of safety, the recording apparatus 1 is preferably mounted in the place where the recording apparatus 1 does not prevent driving operations of the driver. Also, from the viewpoint of avoiding defective electric connections, the recording apparatus 1 is preferably fixed to the vehicle such that the recording apparatus 1 does not readily move or displace during the running of the vehicle. In view of the foregoing aspects, in this embodiment, a Velcro is attached on the recording apparatus 1 for mounting the recording apparatus 1 on a floor mat under a seat with the Velcro. In this way, the recording apparatus 1 can be securely fixed with a high removability without impeding the driver in his or her driving operations. Other than using the Velcro, means for fixing the recording apparatus 1 may be bolts and screws used to fix the recording apparatus 1 to a seat frame under a passenger seat.

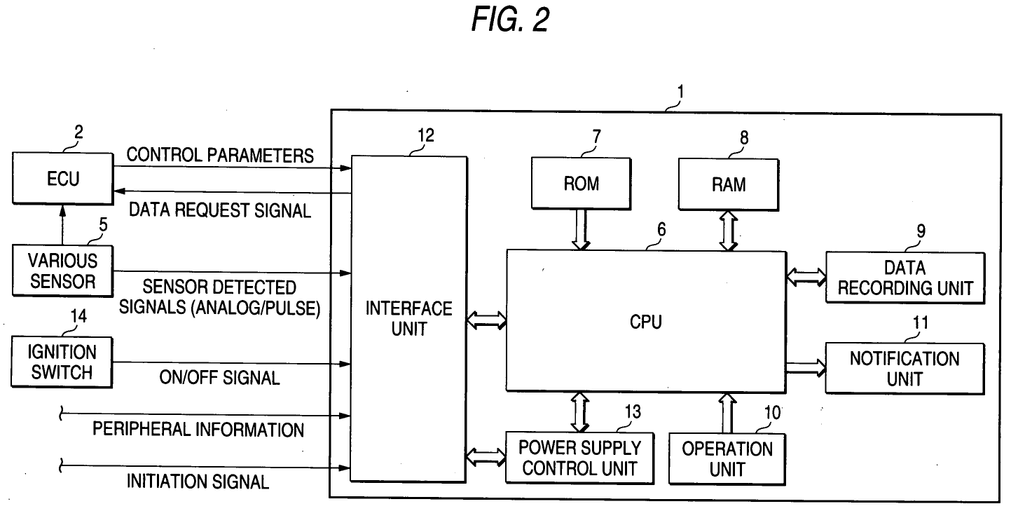

FIG. 2 is a block diagram illustrating the system configuration of the recording apparatus 1. The recording apparatus 1 is mainly configured by a CPU 6 connected to a bus to which a ROM 7, a RAM 8, a data recording unit 9, an operation unit 10, a notification unit 11, an interface unit 12, and a power supply control unit 13 are connected. The CPU 6 governs the control of the overall recording apparatus 1 by reading a control program stored in the ROM 7 and performing the process in accordance with the program. The CPU 6 is responsible for functions of a data control unit, a shutdown processing unit, and an initiation processing unit. The data control unit records time-series vehicle data acquired from the vehicle based on the acquisition contents in accordance with the acquired condition. The shutdown processing unit in turn records in the data recording unit 9 an operation history which includes the acquisition contents, the acquired condition, and a current operating state in the data control unit (i.e., recording apparatus 1) in the shutdown processing (at step 4, later described) which is performed before the power supply is shutdown. The initiation processing unit reads the operation history recorded in the data recording unit 9 in the initiation processing which is performed after the power supply is turned on, and restores the operating state at the time of shutdown based on the read operation history.

The RAM 8 forms a work area for temporarily storing various processed data and the like processed by the CPU 6, and has a function of a buffer for temporarily recording the vehicle data acquired in time series.

A sequence of vehicle data recorded in the RAM 8 is recorded in the data recording unit 9, which is accessible by an external system, by the CPU 6 on the premise that a condition, later described, is established. In this embodiment, in consideration of a utilization of the data recorded in the data recording unit 9, the data recording unit 9 is implemented by a removable card type non-volatile memory, for example, a flash memory type memory card. Therefore, the recording apparatus 1 is provided with a socket (or a drive) which permits the CPU 6 to access to the memory card. When the recording apparatus 1 is installed in the vehicle, the service person previously inserts the memory card into the socket. In this way, the CPU 6 can record the vehicle data on the memory card which is equivalent to the data recording unit 9, and read the information recorded on the memory card. This type of the memory cards includes various storage media such as smart media, an SD memory card, and the like which can be used in the present invention. The memory cards have various recording capacities ranging from 8 MB to 1 GB, so that the memory card having a predetermined storage capacity can be used at will.

Mode files have been previously recorded in the memory card which functions as the data recording unit 9. The CPU 6 reads a mode file from the data recording unit 9 to set an operating state of the recording apparatus 1, i.e., an operating state as a data control unit. The mode file is appropriately set to define a condition under which the vehicle data can be acquired for effectively identifying a faulty state which has been previously assumed to be experienced by the vehicle through experiments and simulations.

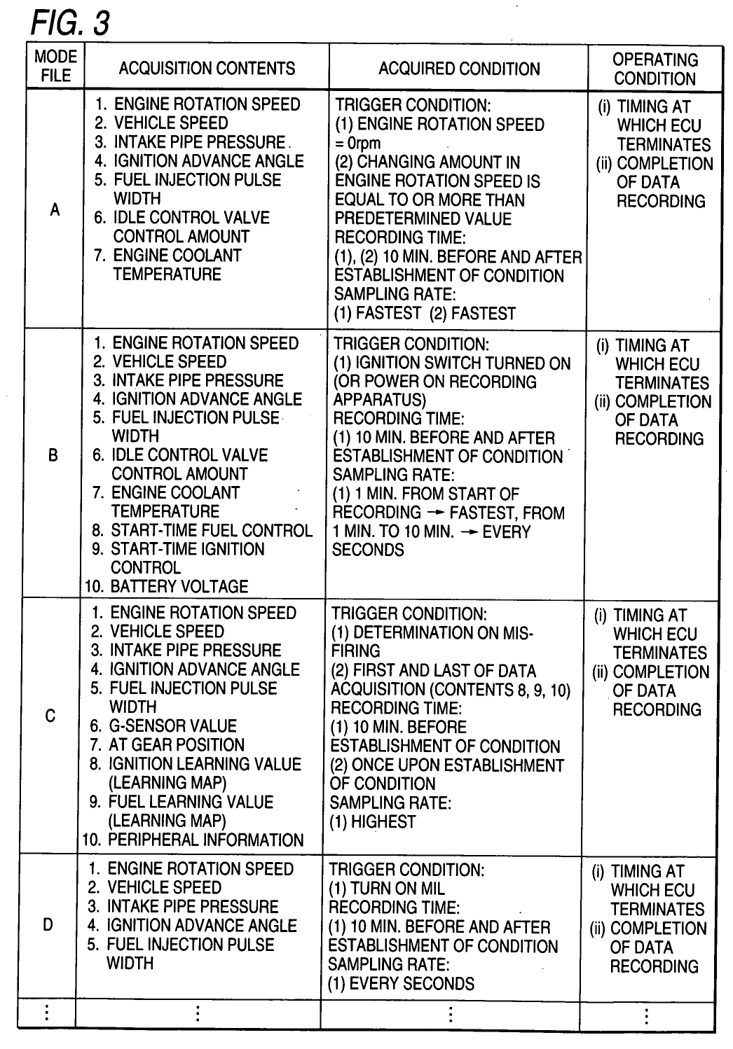

FIG. 3 is an explanatory diagram showing examples of the mode files. Each of the mode files has acquisition contents, an acquired condition, and an operating condition. The acquisition contents indicate the type of the vehicle data to be recorded. The acquired condition refers to a condition under which the vehicle data is acquired and recorded in accordance with the acquisition contents, and includes a sampling rate, a trigger condition, a recording time, and the like. The sampling rate indicates a period at which the vehicle data are acquired, and various periods are set in accordance with the acquisition contents. The trigger condition indicates the condition under which the acquired vehicle data are recorded from the RAM 8 to the data recording unit 9. The trigger condition may include a predetermined point (for example, the vehicle speed at 0 km/h, the engine rotation speed at 0 rpm) in a temporal transition of vehicle data, the ignition switch which is turned on, the generation of a fault code such as misfiring determination, the start and end of data acquisition, a MIL lamp which is turned on, and the like. The recording time indicates a temporal length of the vehicle data recorded in the data recording unit 9 from the RAM 8, and may be, for example, ten minutes before and after the establishment of the trigger condition, and the like. The operating condition refers to the condition under which a transition is made to the termination of the operation of the recording apparatus 1 (shutdown processing, later described). Since the recording apparatus 1 must be temporally linked to the operation of the ECU 2 for recording the vehicle data, the termination of the operation of the ECU 2 is basically set as this operating condition (operating condition (i) in FIG. 3).

When the vehicle data is recorded in the data recording unit 9 in accordance with acquisition contents and acquired condition, it is presumably possible that the acquisition contents and the acquired condition are not satisfied in the subsequent operation cycle (completion of data recording). For example, as a mode file B shown in FIG. 3, where the acquired condition states that the vehicle data is recorded for ten minutes after the ignition switch 14 is turned on, the data recording is completed after the vehicle data is recorded in the data recording unit 9 for ten minutes. In such a case, even if the ECU 2 continues to operate, the recording apparatus 1 hardly needs to operate because there occurs no situation in which the vehicle data should be recorded. Therefore, the mode file also includes a secondary operating condition which is set on the condition that the data recording is completed (operating condition (ii) in FIG. 3).

In the example shown in FIG. 3, a mode file A assumes rough idle as a faulty state. According to this mode file A, the recording apparatus 1 acquires the vehicle data such as the engine rotation speed, a vehicle speed, an intake pipe pressure, an ignition advance angle, a fuel injection pulse width, a control amount of an idle control valve, and a coolant temperature at the highest sampling rate (for example, 10 msec). Also, during the period in which the vehicle data is being acquired, the vehicle data is recorded in the data recording unit 9 for ten minutes before and after the timing when a trigger condition which states that the engine speed reaches zero rpm is established. Alternatively, the vehicle data is recorded in the data recording unit 9 for ten minutes before and after the timing when a trigger condition, which states that a changing amount in the engine speed is equal to or more than a predetermined value, is established. Then, in principle, the acquisition and recording of the vehicle data are terminated on the basis of the termination of the operation of the ECU 2, followed by a transition to the shutdown processing (when data recording is completed, a transition is made to the shutdown processing at this timing at which the data recording is completed). On the other hand, a mode file B assumes a defective engine start as a faulty state, while a mode file. C assumes abnormal vibrations such as surge as a faulty state. Unlike these mode files, a mode file D does not assume a particular faulty situation, but corresponds to wide applications for acquiring minimum vehicle data in various faulty situations.

A mode file is associated with a plurality of the files each corresponding to a different faulty state. Therefore, the recording apparatus 1 is installed in the vehicle, after the mode file shave been appropriately selected in correspondence to the faulty situations of the vehicle in which the recording apparatus 1 is installed, and recorded on the memory card. The selection of the mode files and recording of the mode files on the memory card are performed by the service person with reference to diagnosis codes stored in a backup RAM of the ECU 2.

The operation unit 10 comprises a remote controller provided with an operation switch. The remote controller can be operated by the driver. As the driver operates the operation switch, an operation signal is outputted from the operation unit 10 to the CPU 6, causing the CPU 6 to record the vehicle data recorded in the RAM 8 in the data recording unit 9. In other words, a manipulation on the operation switch functions as a trigger condition at an arbitrary timing by the driver. The operation unit 10 may further comprise input means such as the keyboard, the mouse, and the like.

The notification unit 11 notifies the user of the completion of recording when the recording of the vehicle data which satisfies the acquired condition has appropriately completed. In this embodiment, the notification unit 11 mainly comprises LED which is controlled to turn on or blink when the recording of the vehicle data described in the acquired condition is appropriately terminated. In this way, the user can be effectively notified of the completion of the recording of the vehicle data. Alternatively, the notification unit 11 may comprise a CRT, a liquid crystal display, a speaker, or the like, and can employ various configurations which can notify the driver of the completion of the recording.

The interface unit 12 includes various interfaces for sending and receiving the data to and from the vehicle. The recording apparatus 1 is connected to the CAN or the K-Line in the vehicle through the interface unit 12 for bi-directional communications with the ECU 2 in the vehicle. In this way, the recording apparatus 1 can acquire control parameters from the ECU 2, and can know the situation of the ECU 2 such as the generation of a diagnosis code. Also, the interface unit 12 is applied with output signals from various sensors provided in the vehicle directly or indirectly through the ECU 2, and is also applied with signals associated with the ignition switch 14 when it is turned on and off (ON signal/OFF signal). Further, the recording apparatus 1 can make the bi-directional communications with a general-purpose computer (external PC) which is an external system connected thereto from the outside through the interface unit 12.

The power supply control unit 13 controls the power supply for the recording apparatus 1. The recording apparatus 1 is connected to a battery 15 (see FIG. 1) provided in the vehicle, and operates with the power supplied from the battery 15. Thus, the power supply control unit 13 can switch ON or OFF the recording apparatus 1 as required by controlling the power supplied from the battery 15. Upon a power-on, the power supply control unit 13 monitors the interface unit 12 to perform this based on a predetermined signal input or a change in a signal.

On the other hand, upon a power-off, the power supply control unit 13 performs this in response to an instruction signal outputted from the CPU 6 in synchronism with the termination of the shutdown processing.

For ensuring the power supply required by the recording apparatus 1 to operate even if the power from the battery 15 is shut down, the recording apparatus 1 is provided with a sub-battery (not shown). The sub-battery comprises, for example, a capacitor or the like for storing a predetermined static capacitance. The power stored in the sub-battery is supplied to various circuits which make up the recording apparatus 1 as required when an electric connection is broken between the battery 15 and the recording apparatus 1. Also, though not shown in FIG. 2, the recording apparatus 1 is provided with a clocking function for defining a current date and time, and a timer function for detecting a timing of a predetermined period.

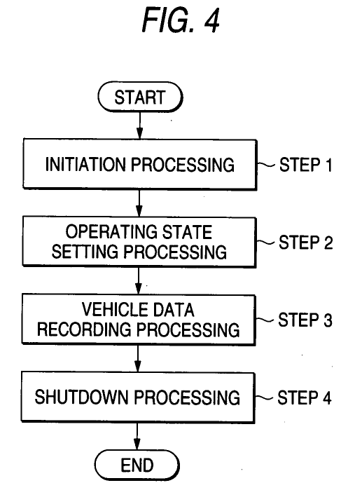

FIG. 4 is a flow chart illustrating a data recording procedure according to this embodiment. The procedure of the recording processing performed by the recording apparatus 1 proceeds in the order of the initiation processing, the operating state setting processing, the data recording processing, and the shutdown processing.

Initiation Processing (Step 1)

From the viewpoint of reducing a power consumption of the battery 15, the recording apparatus 1 is basically powered off when the engine is stopped. Thus, the recording apparatus 1 is powered on at the time the vehicle is started, followed by the initiation of the system such as the operating system of a computer. At this time, the recording apparatus 1 preferably has initiated the system of the recording apparatus 1 before the ignition switch 14 is turned on such that the vehicle data can be recorded upon starting the engine. Thus, the recording apparatus 1 performs the initiation processing by using one of approaches 1-3 shown below or in combination of a plurality of approaches.

Approach 1 (Initiation before the Ignition Switch 14 is Turned On)

When the ignition switch 14 is turned on, the driver's get-in behavior or entrance exists as its premise. As such, the recording apparatus 1 senses the driver's get-in behavior which is relied on to turn on the power supply. A determination as to whether or not the driver gets in the vehicle can be made by sensing the release of a door lock. Therefore, the interface unit 12 can be applied with a door lock release signal received from a transmitter in a key-less entry system, or with a control signal for releasing the door lock in the ECU 2 as an initiation signal. Then, as the interface unit 12 is applied with the door lock release signal or door lock release control signal, the power supply control unit 13 powers on based on the control signal.

Other than the released door lock, the driver's get-in behavior can be determined by detecting a signal from a smart key system, seating on a seat, a touch to a door, and vibrations of the vehicle caused by opening and closing a door. Whether or not the driver is seated on the seat can be determined by a seat sensor for detecting a pressure load on the surface of the seat. Also, a touch to the door, or opening/closing of the door can be sensed by providing the vehicle with a touch sensor for detecting a touch of the driver to the door, or with a vibration sensing sensor. As such, the power supply control unit 13 may power on when any of detection signals of these sensors or a combination of some of these detection signals is applied to the interface unit 12, based on the detection signal(s).

Approach 2 (Initiation in Synchronism with On-Timing of Ignition Switch 14)

When the interface unit 12 is applied with an ON-signal outputted from the ignition switch 14, the power supply control unit 13 powers on based on the ON-signal. Alternatively, when the ignition switch 14 is turned on to cause a change in a communication signal on the CAN in the interface unit 12, the power supply control unit 13 may power on based on this change in the signal.

Approach 3 (Initiation after Ignition Switch 14 is Turned On)

When the power supply control unit 13 is applied with a timer signal every predetermined time from a built-in timer (not shown), the power supply control unit 13 powers on based on the timer signal. As the system has been initiated in association with the power-on, the CPU 6 outputs some data request signal to the ECU 2 in the vehicle. Generally, when the vehicle has started, the ECU 2 is operating, so that a signal in response to this data request signal should be outputted from the ECU 2. Thus, it is determined whether or not the vehicle has started based on whether or not the signal outputted from the ECU 2 has received. The recording apparatus 1 continues the initiated state when it receives the signal from the ECU 2. On the other hand, when the recording apparatus 1 does not receive a predetermined signal even though it has outputted a data request signal, the recording apparatus 1 terminates the system, and instructs the power supply control unit 13 to turn off the power supply. Then, the power supply control unit 13 again turns on the power supply in response to an applied timer signal, and repeatedly executes a similar processing.

Other than the foregoing, a power supply switch may be provided on a remote controller equivalent to the operation unit 10, such that the user himself may power on the recording apparatus 1 before the ignition switch 14 is turned on. In this case, the power supply control unit 13 powers on based on a manipulation signal generated in response to the manipulation on the power supply switch.

As the recording apparatus 1 is powered on to cause the system to initiate, it is first determined whether or not the amount of the power stored in the sub-battery is equal to or less than a predetermined capacity. The sub-battery supplies the recording apparatus 1 with the amount of battery at least required for performing the shutdown processing when the power from the battery 15 provided in the vehicle is shut down. Therefore, if the sub-battery initially does not have enough power for executing the shutdown processing, the sub-battery must be recharged. This is why the determination is made as to whether or not the power is enough for permitting the recording apparatus 1 to safely terminate immediately after the system is initiated. When the determination is made as positive, i.e., when the power stored in the sub-battery is equal to or less than the predetermined capacity, the sub-battery is recharged before the procedure proceeds to step 2 which is one step of the initiation processing. On the other hand, when the determination is made as negative, i.e., when the power stored in the sub-battery is more than the predetermined capacity, the procedure proceeds to step 2 without recharging the sub-battery.

Operating State Setting Processing (Step 2)

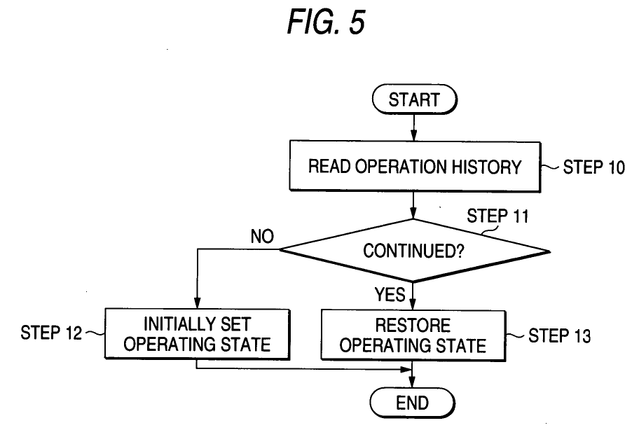

FIG. 5 is a flow chart which illustrates a procedure of operating state setting processing at step 2. First, the operation history stored in the data recording unit 9 is read (step 10) to determine whether or not the recording unit 1 has been continuing an operation when it was shut down in the preceding operation cycle (step 11). This operation history is the information recorded in the data recording unit 9 when the shut down processing is performed, and describes the operating state of the recording apparatus 1, i.e., how the vehicle data has been recorded in the CPU 6 at the time of the shutdown.

Specifically, the operation history includes operation information showing whether the data recording has not been completed so that the recording apparatus 1 was still continuing the operation, or the data recording has completed. Here, “continuing the operation” means that the CPU 6 is continuing to acquire the vehicle data, or that the CPU 6 is recording the vehicle data in the data recording unit 9. Also, when an operation is continuing, the operation history records parameter information required to restore a current operating state of the recording apparatus 1, including the acquisition contents, the acquired condition, and to which state the recording has been performed.

When the determination is made as negative at step 11, i.e., when the recording apparatus 1 has not been continuing the operation (completion of data recording), the procedure proceeds to step 12. When the recording apparatus 1 is initially installed in the vehicle so that the operation history has not been recorded in the data recording unit 9, it is also determined that the recording apparatus 1 has not been continuing the operation, causing the procedure to proceed to step 12 in a similar manner. Then, at step 12, an initial setting is made for the operating state based on data for an initial setting. Specifically, the acquisition contents described in the mode file recorded in the data recording unit 9 is read and set as the vehicle data which should be acquired from the vehicle side. The acquired condition is also read to set conditions related to the acquisition and recording of the vehicle data. In this way, the recording apparatus 1 is set to perform the acquisition and recording operations in accordance with the mode file.

On the other hand, if the determination is made as positive, i.e., when the recording apparatus 1 has been continuing the operation, the procedure proceeds to step 13. Then, at step 13, the operation history is set. Specifically, the operating condition is set for the recording apparatus so as to restore the operating state at the preceding shutdown with reference to the operation information and parameter information.

Data Recording Processing (Step 3)

When the operating state is set at the foregoing step 2, a data request signal is first outputted to the ECU 2 in order to acquire control parameters which were set as the acquisition contents. The ECU 2 is executing a normal system control in association with the start of the vehicle, and upon receipt of the data request signal, the outputs control parameters which meet the acquisition contents to the recording apparatus 1, while executing the system control, until its own operation is terminated. Therefore, upon receipt of the control parameters in response to the data request signal, the recording apparatus 1 acquires the received control parameters at a predetermined sampling rate, and records the acquired control parameters in the RAM 8 in the time series.

Also, when the acquisition contents include the vehicle data other than the control parameters for the ECU 2, i.e., sensor detected signals and peripheral information, the recording apparatus 1 also acquires these data through the interface unit 12, and records the data in the RAM 8 in the time series. When data corresponding to the acquisition contents exists both in the control parameters (operated values) for the ECU 2 and the sensor detected signals, such as the engine speed, the recording apparatus 1 can acquire the sensor detected signals together with the control parameters and stores both data in the RAM 8. The peripheral information can be acquired as the sensor-detected signals from the respective sensors by individually mounting the sensors for detecting the peripheral information together with the recording apparatus 1. However, when the vehicle is equipped with sensors capable of detecting such an information (for example, a thermometer and GPS), the output signals may be utilized.

Then, when the trigger condition is established during the acquisition of the data, the vehicle data recorded on the RAM 8 are recorded in the data recording unit 9 in accordance with the acquired condition. For example, in the mode file A shown in FIG. 3, when the engine speed being acquired falls down to zero rpm, the trigger condition is determined to be established. In this case, the vehicle data for five minutes before the timing at which the trigger condition is established is read from the RAM 8 and recorded in the data recording unit 9. Together with this, the vehicle data stored in the RAM 8 for five minutes after the timing, at which the trigger condition is established, is recorded in the data recording unit 9.

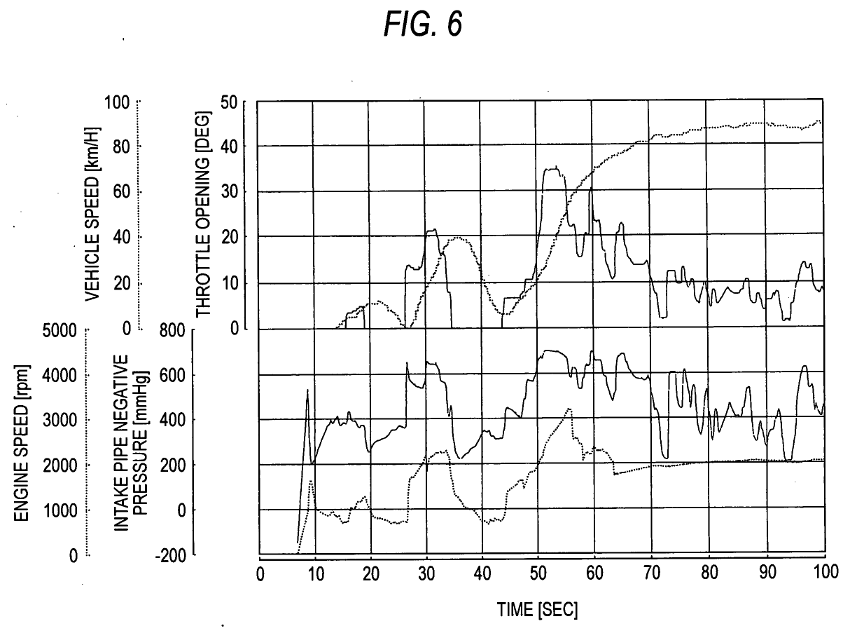

FIG. 6 is an explanatory diagram showing a change over time of time-series vehicle data recorded in the data recording unit 9. FIG. 6 shows the vehicle data including the vehicle speed (km/h), the throttle valve opening degree (deg), the engine speed (rpm), and the intake pipe negative pressure (intake pipe pressure) (mmHg). As shown in FIG. 6, the vehicle data recorded in the data recording unit 9 are recorded in correspondence to the temporal information at the time of the acquisition. Used for this time information is an absolute time represented by the date and time, or a relative time represented by a lapsed time from the start of recording.

When the data recording is completed in association with the establishment of the trigger condition, a completion processing is executed for the recording operation. In this completion processing, the notification unit 11 is controlled to turn on the LED, and the acquisition of the vehicle data outputted from the ECU 2 is stopped. Then, a transition is made to the shutdown processing, later described. On the other hand, when the data recording has not been completed even though the trigger condition is established, the data acquisition is continued until the trigger condition is again established.

As shown in the operating condition in the mode file, the data recording operation terminates together with the termination of the operation of the ECU 2 to be recorded except for the case where the data recording is completed within one operation cycle. Generally, each of control units which make up the ECU 2 has an operation termination timing which is individually set. For example, the ABS-ECU terminates its operation at the timing at which the ignition switch 14 is turned off, whereas the E/G-ECU 2a operates for a certain time period even after the ignition switch 14 is turned off, and then terminates the operation, and so forth. In this way, the operation terminates at a different timing depending on the ECU 2 to be recorded, so that the recording apparatus 1 itself is required to monitor the ECU 2 for an operating situation in order to terminate the data recording operation at an appropriate timing. As such, in this embodiment, the ECU 2 is determined as for the termination of the operation on the condition that no vehicle data is received from the ECU 2 even though the data request signal is outputted. However, since the ECU 2 can be temporarily inoperative, the recording apparatus 1 outputs the data request signal at a predetermined number of times. Then, when no data has been received after outputting the data request signal after this number of times, a transition is made to the shutdown operation.

Even during a sequence of data record process being performed, the recording apparatus 1 is still monitoring a power supply line connected to the battery 15 of the vehicle. When the power supply is shut down, the procedure proceeds to the shutdown processing at step 4. In this case, the recording apparatus 1 is supplied with the power from the sub-battery, not shown, and operates with this power.

Shutdown Processing (Step 4)

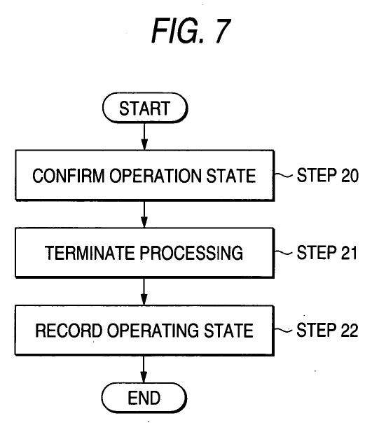

FIG. 7 is the flow chart illustrating a detailed procedure of the data recording processing at step 4. First, a current operating state of the recording apparatus 1 is confirmed (step 20). With this confirmation, the operating state of the recording apparatus 1 is classified into one of acquisition of the vehicle data, recording of vehicle data, and completion of data recording. Here, during the acquisition of the vehicle data, data is being acquired from the vehicle without the establishment of the trigger condition. During the recording of the vehicle data, the vehicle data stored in the RAM 8 is being recorded in the data recording unit 9 with the establishment of the trigger condition.

At step 21, a termination processing is performed. This processing involves a transition to the state in which the recording apparatus can be safely powered off because the recording apparatus 1 is still continuing the operation in the state other than the completion of the data recording. Therefore, if the operating state is confirmed to be the completion of the data recording at step 20, this step is skipped. When the vehicle data is being acquired at step 21, the acquisition of the vehicle data is stopped. When the vehicle data is being recorded, the acquisition of the vehicle data is stopped, and unrecorded vehicle data is recorded in the data recording unit 9.

At step 22, the operation history comprised of parameter information and state information is recorded in the data recording unit 9 based on the confirmed current operating state.

The parameter information is minimally required information for restoring the operating state upon the termination at the next start, and includes the acquisition contents, addresses in the RAM 8 at which the data have been stored, the acquired condition, and the like. The state information refers to the confirmed operating state of the recording apparatus 1, and one of the vehicle data acquisition, recording of the vehicle data, and completion of the data recording is recorded. As the operation history has been recorded, this routine exits, and together with this, the power supply is shut down.

As described above, according to the embodiment of the present invention, the operating state of the recording apparatus 1 at a start is set based on the operating state of the recording apparatus 1 which has been recorded when shut down. In this way, since the operating state of the recording apparatus 1 can be made continuous at the end of the preceding operation cycle and at the start of the current operation cycle, this is effective when data is recorded over a plurality of cycles. As later described, this operation history records only minimally required contents for restoring the recording apparatus 1 to a state similar to the preceding operating state when shut down at the last time. For this reason, even if the operation history is read to restore the operating state, the time required therefor is shorter than the time required when the mode file is read. As a result, even when the vehicle data is recorded immediately after the recording apparatus 1 is started, it is possible to improve a response ability to the recording operation of the recording apparatus 1.

Also, according to the recording apparatus 1, even if the power supply is shut down from the vehicle to the recording apparatus 1, the recording apparatus 1 is supplied with the power from the sub-battery. Since this enables the processing (shutdown processing) for safely terminating the recording apparatus 1, it is possible to suppress a failure in recording the vehicle data. In addition, when the sub-battery stores a small amount of the power at a start, the sub-battery can be recharged, thus ensuring the safety for the operation of the recording apparatus 1.

Further, the data recording unit 9 is not limited to the memory card of the flash memory type, but various recording media can be widely applied, such as a magnetic type, an optical type, and the like. In this case, the vehicle data stored in the RAM 8 is stored on a recording medium through various drives controlled by the CPU 6. As will be understood from the foregoing, the data recording unit 9 in the present invention need not be an essential component of the recording apparatus 1. In other words, the recording apparatus 1 is required to be capable of at least recording the vehicle data in the data recording unit 9. However, the data recording unit 9 need not be removable, but may be integrated with the recording apparatus 1.

It will be understood to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A data recording apparatus comprising:
a data recording unit for storing vehicle data and being accessible by an external system, wherein the vehicle data includes a control parameter in a control unit equipped in a vehicle;
a data control unit for recording time-series vehicle data in the data recording unit in accordance with an acquired condition, wherein the time-series vehicle data are acquired from the vehicle based on an acquisition content indicative of a type of the vehicle data to be recorded in the data recording unit, and wherein the acquired condition is a condition under which the vehicle data can be acquired for effectively identifying a faulty state of the vehicle;
a shutdown processing unit for recording an operation history in the data recording unit during a shutdown processing, wherein the operation history includes the acquisition contents, the acquired condition, and a current operating state of the data control unit, and wherein the shutdown processing is performed before the data recording apparatus is powered off; and
an initiation processing unit for reading the operation history recorded in the data recording unit and for restoring the operating state at the time of the shutdown processing based on the read operation history during an initiation processing performed after turning on the power supply.

2. The data recording apparatus according to claim 1, wherein the initiation processing unit sets the operating state of the data control unit based on initially set data previously recorded in the data recording unit when the operation history is not recorded in the data recording unit.

3. The data recording apparatus according to claim 1, further comprising:
a sub-battery for supplying a power to the data recording apparatus when the power supplied from the vehicle to the data recording apparatus is shut down,
wherein, during the initiation processing, the initiation processing unit recharges the sub-battery using the power supplied from the vehicle to the data recording apparatus when the power stored in the sub-battery is equal to or less than a predetermined amount.

4. The data recording apparatus according to claim 1, further comprising:
a power supply control unit for turning on the power supply based on a detection signal outputted from the vehicle when a driver's get-in behavior is sensed.

5. The data recording apparatus according to claim 4, wherein the power supply control unit turns on the power supply based on an ON signal outputted from the vehicle when an ignition switch provided in the vehicle is turned on.

6. The data recording apparatus according to claim 4, wherein the power supply control unit turns on the power supply based on a change in a communication signal outputted from the control unit when the ignition switch is turned on.

7. The data recording apparatus according to claim 4, wherein the power supply control unit turns on the power supply based on a timer signal outputted every predetermined time, and
wherein the initiation processing unit outputs a data request signal to the control unit, performs the initiation processing when the initiation processing unit receives a predetermined signal corresponding to the data request signal from the control unit, and indicates the power supply control unit to shutdown the power supply when determining that the initiation processing unit does not receive the predetermined signal.

8. A data recording method for data recording apparatus for recording a vehicle data including a control parameter in a control unit of a vehicle in a data recording unit accessible by an external system, comprising:
recording time-series vehicle data in the data recording unit in accordance with an acquired condition, wherein the time-series vehicle data is acquired from the vehicle based on acquisition contents indicative of the type of the vehicle data to be recorded in the data recording unit, and wherein the acquired condition is a condition under which the vehicle data can be acquired for effectively identify a faulty state of the vehicle;
storing an operation history in the data recording unit during a shutdown processing, wherein the operation history includes the acquisition contents, the acquired condition, and a current operating state of the data control unit, and wherein the shutdown processing is performed before the data recording apparatus is powered off;
reading the operation history recorded in the data recording unit and restoring the operating state at the time of the shutdown processing based on the read operation history during an initiation processing performed after turning on the power supply.

9. The data recording method according to claim 8, further comprising:
setting an operating state of the data control unit based on initially set data previously recorded in the data recording unit when the operation history is not recorded in the data recording unit.

10. The data recording method according to claim 8, further comprising:
recharging a sub-battery using the power supplied from the vehicle to the data recording apparatus when the power stored in the sub-battery is equal to or less than a predetermined amount during the initiation processing; and
supplying the power from the sub-battery to the data recording apparatus when the power supplied from the vehicle to the data recording apparatus is shut down.
